(19) United States
(12) Patent Application Publication
(10) Pub. No.: US 2025/0268383 A1
(43) Pub. Date: Aug. 28, 2025

(54) POSITIONAL SUPPORT DEVICE AND METHOD

(71) Applicant: OMNIA MEDICAL, LLC, Morgantown, WV (US)

(72) Inventor: Troy Schifano, Morgantown, WV (US)

(21) Appl. No.: 19/064,813

(22) Filed: Feb. 27, 2025

Related U.S. Application Data
(60) Provisional application No. 63/558,214, filed on Feb. 27, 2024.

(51) Int. Cl. A47C 7/42

(52) U.S. Cl. CPC A47C 7/425

(57) ABSTRACT

A positional support device includes a bottom surface, a top surface, and a front surface. The bottom surface has a flat portion extended in a front-back direction and a left-right direction. The top surface extends straight along the front-back direction, and is offset from the bottom surface in a top-bottom direction. The front surface extends along the front-back direction, and is inclined in the top-bottom direction from the top surface toward the bottom surface. The positional support device also includes a middle portion interposed between and separating a first end portion and a second end portion in the left-right direction. The first end portion or the second end portion extend beyond the middle portion in the top-bottom direction along the front surface and the top surface, or the first end portion or the second end portion are dense or rigid as compared to the middle portion.

### TECHNICAL FIELD

The present disclosure relates generally to medical devices and medical methods. More particularly, the present disclosure relates to a positional support device for use in treatment of the sacroiliac joint.

### BACKGROUND

Lower back pain is a common ailment among the population and results in both pain and suffering as well as loss of work time. Thus, approaches for the treatment of back pain can both relieve suffering as well as reduce employee down time. Therefore, effective treatments for lower back pain have both economic benefits as well as the benefit of alleviating considerable suffering.

The sacroiliac (SI) joint is located in the lower back at the juncture of the ilium, the upper bone of the pelvis, and the sacrum at the base of the spine. While the sacroiliac joint has a limited range of motion, dysfunction of the joint has been identified. The joint is supported by a range of ligaments including, for example, the sacroiliac ligament at the base of the joint and the anterior sacroiliac ligament at the top of the joint.

High energy pelvic ring injuries that involve disruption of the SI joint and/or displaced fractures of the sacrum present unique challenges to the orthopedic traumatologist. Some sacral fractures require solid posterior stabilization, which may be difficult to achieve with typical treatment methods. Furthermore, vertically unstable sacral fractures/SI joint disruptions have a relatively high incidence of neurovascular injury and may require unique stabilization. Typically, a spinal surgeon will be involved to perform lumbo-pelvic stabilization of these injuries to provide vertical stability to the injury. However, there may be significant soft tissue trauma associated with these injuries, making extensive surgical approaches of elevated risk in terms of infection and wound complications.

Immobilization of the SI joint can result in significant relief of lower back pain. Current techniques and instrumentation systems may require extensive surgical exposure and dissection. Moreover, such instrumentation systems are typically designed for other applications, and not to connect and stabilize the lumbar spine and pelvis. As a result, this can make the surgical times longer and more frustrating for surgeons and surgical staff. For example, traditional posterior iliac screws are often prominent because the posterior iliac crest is relatively subcutaneous. Yet, this sometimes makes hardware painful for the patient and at risk for pressure soreness following surgery.

### SUMMARY

According to one aspect, a positional support device includes a bottom surface, a top surface, and a front surface. The bottom surface has a flat portion that extends in a front-back direction and a perpendicular left-right direction. The top surface extends straight along the front-back direction, and is offset from the bottom surface in a top-bottom direction perpendicular to the front-back direction and the left-right direction. The front surface extends along the front-back direction, inclined in the top-bottom direction from the top surface toward the bottom surface. The positional support device also includes a first end portion and a second end portion extended opposite from the first end portion in the left-right direction, and includes a middle portion interposed between and separating the first end portion and the second end portion in the left-right direction. The first end portion or the second end portion extend beyond the middle portion in the top-bottom direction along the front surface and the top surface, or the first end portion or the second end portion are dense or rigid as compared to the middle portion.

According to another aspect, a method of using a positional support device includes placing a bottom surface of the positional support device on a horizontal support surface, where the bottom surface extends along the support surface in a front-back direction and a perpendicular left-right direction. The method also includes laying a patient in a prone position on the support surface, over the positional support device, where a top surface of the positional support device is offset from the bottom surface in a top-bottom direction perpendicular to the front-back direction and the left-right direction, extends straight along the front-back direction, and receives an anterior portion of a pelvis of the patient. A front surface of the positional support device extends along the front-back direction, inclined downward in the top-bottom direction from the top surface toward the bottom surface, receives the pelvis of the patient, and is located closer to feet of the patient. A back surface of the positional support device extends downward from the top surface toward the bottom surface at a smaller angle from the top-bottom direction than the front surface, such that an abdomen of the patient separates from and extends beyond the back surface in the front-back direction.

According to another aspect, a method of manufacturing a positional support device includes forming a body having a first end portion, a second end portion extended from the first end portion in a left-right direction, and a middle portion interposed between and separating the first end portion and the second end portion in the left-right direction. The middle portion includes a bottom surface that has a flat portion extended in the left-right direction and a perpendicular front-back direction. The middle portion includes a top surface that extends straight along the front-back direction, and is offset from the bottom surface in a top-bottom direction perpendicular to the left-right direction and the front-back direction. The middle portion includes a front surface that extends along the front-back direction, inclined in the top-bottom direction from the top surface toward the bottom surface. The first end portion or the second end portion extend beyond the middle portion in the top-bottom direction along the front surface and the top surface, or wherein the first end portion or the second end portion are dense or rigid as compared to the middle portion.

The innovation described herein introduces a positional support device designed to enhance patient stability and comfort during sacroiliac joint treatments. This device offers ease of placement on various support surfaces and provides ergonomic support for patients in the prone position, effectively elevating and stabilizing the pelvis. In addition to other described features, functions, and benefits, the positional support device enables secure and efficient positioning while reducing pressure on the abdomen, thereby facilitating improved surgical access and minimizing patient discomfort.

### BRIEF DESCRIPTION OF THE DRAWINGS

Aspects of the present disclosure are best understood from the following detailed description when read with the accompanying figures and Appendix. It is noted that, in accordance with the standard practice in the industry, various figures are not drawn to scale. In fact, the dimensions of the various features may be arbitrarily increased or reduced for clarity of discussion.

FIG. 1 is a top-right perspective view of an example positional support device in accordance with aspects of the innovation.

FIG. 2 is a left view of a patient laying articulated in a prone position over the positional support device of FIG. 1.

FIG. 3 is a front perspective view of the positional support device of FIG. 1.

FIG. 4 is a left perspective view of the positional support device of FIG. 1.

FIG. 5 is a right perspective view of the positional support device of FIG. 1.

FIG. 6 is a top-left perspective view of the positional support device of FIG. 1.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4.” The term “about” may refer to plus or minus 10% of the indicated number.

In accordance with some embodiments, there is provided a positional support device that removes the natural spine angle from the patient to allow instruments to access the sacroiliac joint in a more straightforward fashion. In some embodiments, the positional support device is constructed via additive manufacturing processes, e.g., 3-D printing, utilizing a variety of internal shapes and densities in accordance with patient size, e.g., height, hip span, weight, etc. In accordance with other embodiments, the positional support device is configured for rapid production and disposal, e.g., single-use customized per patient. In other embodiments, the positional support device includes a removable sleeve, encompassing the positional support device and allowing for removal and replacement for subsequent patients. In still other embodiments, the positional support device is coated in a non-permeable material, allowing for cleaning and reuse. In some embodiments, the positional support device is comprised of a single material, varying in internal geometries, e.g., shapes, cavities, etc., to enable flexibility thereof in varying degrees.

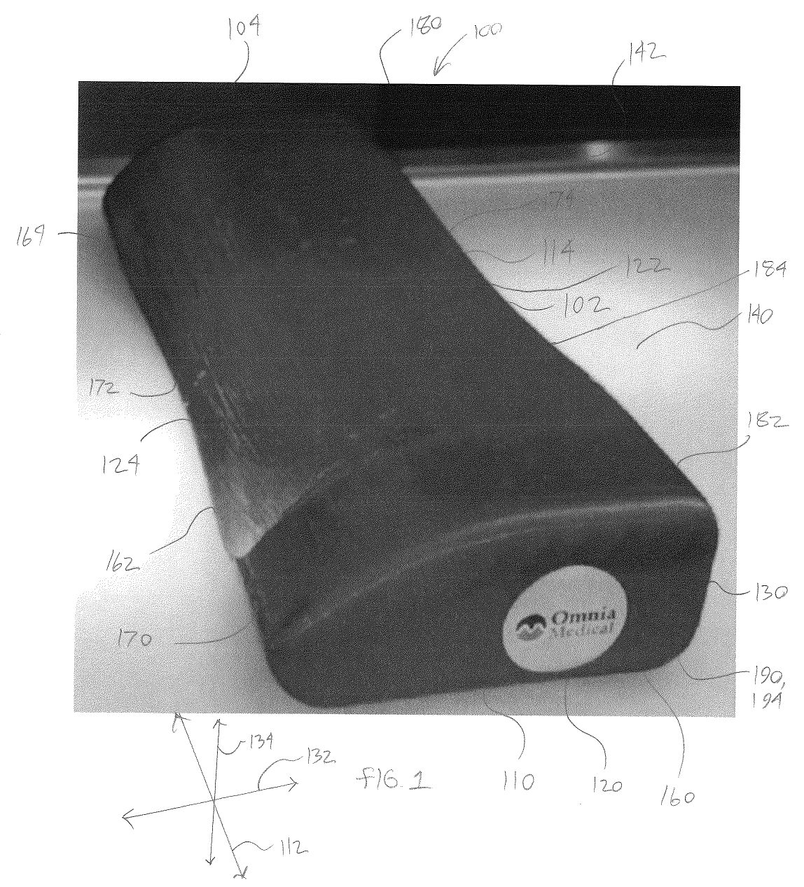

FIG. 1 depicts a right perspective view of a positional support device 100. As shown in FIG. 1, the positional support device 100 includes a body 102 having a first end portion 104 and a second end portion 110 extended opposite from the first end portion 104 in a left-right direction, indicated by an arrow 112. The body 102 also includes a middle portion 114 interposed between and separating the first end portion 104 and the second end portion 110.

The first end portion 104, the second end portion 110, and the middle portion 114 together form a bottom surface 120, a top surface 122, a front surface 124, and a back surface 130 of the positional support device 100. The bottom surface 120 has a flat portion that extends continuously between the first end portion 104, the second end portion 110, and the middle portion 114. In this manner, the bottom surface 120 extends in the left-right direction, and a front-back direction perpendicular to the left-right direction, indicated by an arrow 132.

The top surface 122 extends in the front-back direction parallel to the bottom surface, at a side of the positional support device 100 opposite the bottom surface 120 in a top-down direction perpendicular to the left-right direction and the front-back direction, indicated by an arrow 134. As such, the top surface 122 is offset from the bottom surface 120 in the top-bottom direction, defining a height of the body 102 in the top-bottom direction.

With continued reference to FIG. 1, when the positional support device 100 is placed with the bottom surface 120 laying on a support surface 140 that is horizontal, the positional support device 100 is in an upright position where the top-bottom direction is a vertical direction. While, as depicted, the support surface 140 is formed from a top of an orthopedic table 142, the support surface 140 may additionally or alternatively be formed from various types of tables or other flat extended supports such as, for example, an operating table, a surgical table, a gurney, a stretcher, a bed, or a procedure table without departing from the scope of the present disclosure.

The front surface 124 extends in the front-back direction, and directly connects the bottom surface 120 to the top surface 122. In this regard, the front surface 124 is inclined in the top-bottom direction from the top surface 122 toward the bottom surface 120.

The back surface 130 extends along the top-bottom direction, and connects the bottom surface 120 to the top surface 122 at a side of the positional support device 100 opposite the front surface 124 in the front-back direction. The back surface 130 extends from the top surface 122 toward the bottom surface 120 at a smaller angle from the top-bottom direction than the front surface 124, such that the back surface 130 is steeper than the front surface 124 in the top-bottom direction. In an embodiment, the back surface 130 extends flat in the top-bottom direction and the left-right direction.

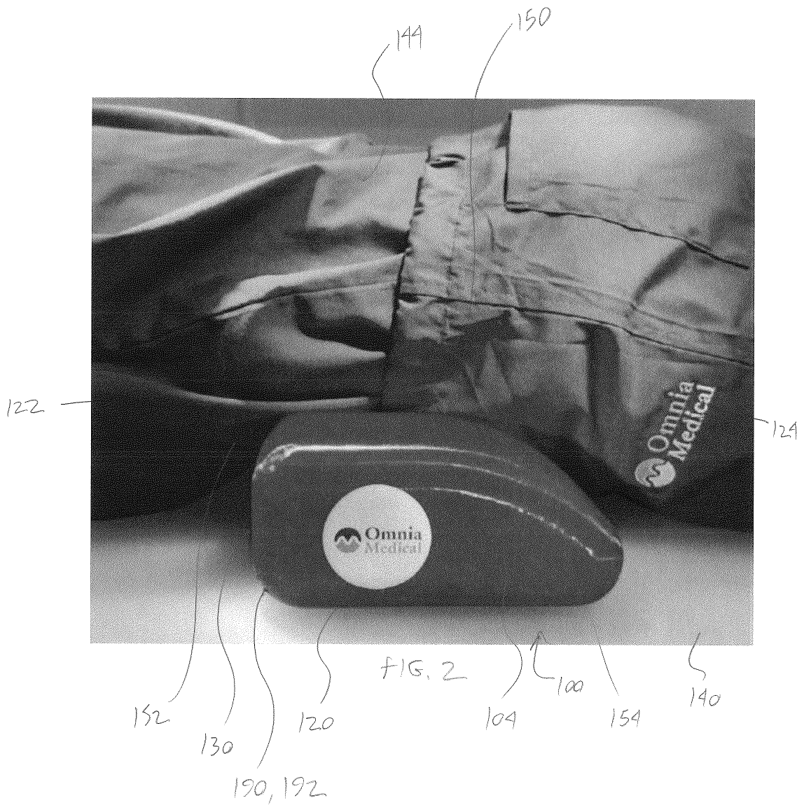

As such, the body 102 has a relatively small footprint at the bottom surface 120 in the front-back direction, reducing a necessary size of the support surface 140 for supporting the positional support device 100 in the front-back direction. Also, as shown in FIG. 2, when a patient 144 is disposed over the positional support device 100 in a prone position, the positional support device 100 supports the patient 144 at the top surface 122 and the front surface 124, and relieves pressure from the patient 144 at the back surface 130. More specifically, the relatively shallow vertical angle of the front surface 124 in the upright position uniformly supports the patient 144 with an elevated posture, evenly dissipating pressure at a pelvis 150 of the patient 144. The back surface 130 is angled downward from the top surface 122 such that the back surface 130 separates the positional support device 100 from the patient 144, avoiding excessive or unnecessary pressure at an abdomen 152 of the patient 144.

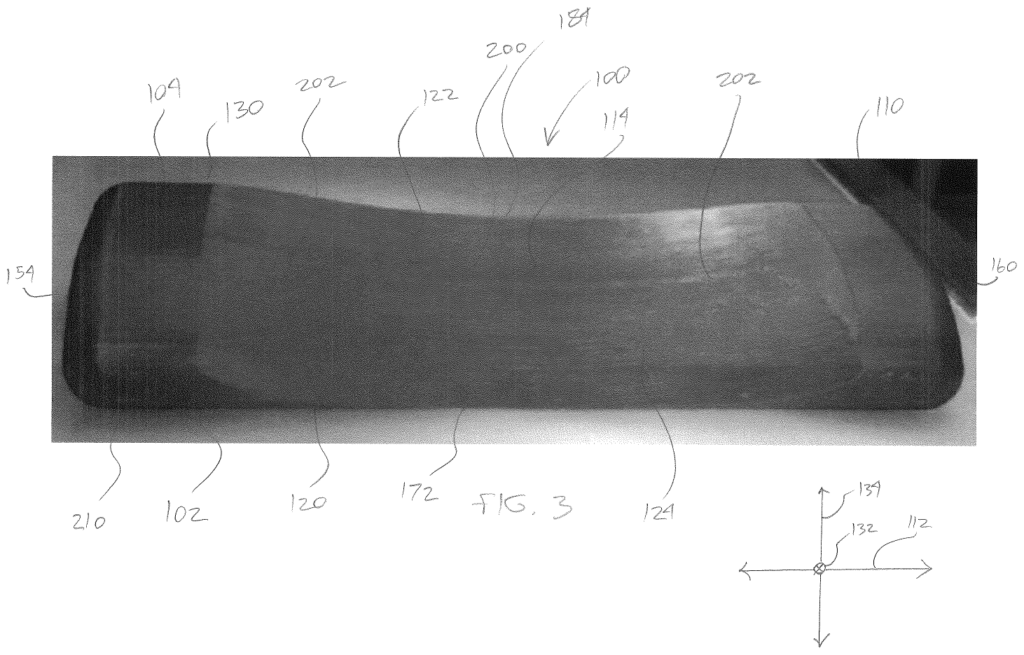

Referring to FIGS. 3-6, the first end portion 104 and the second end portion 110 extend beyond the middle portion 114 along the front surface 124 and the top surface 122 in the top-bottom direction and the front-back direction. In this manner, the first end portion 104 and the second end portion 110 obstruct movement of the patient 144 laying over the middle portion 114 in the left-right direction, relative to the positional support device 100. As such, the first end portion 104 and the second end portion 110 retain the patient 144 articulated in the prone position on the positional support device 100 in the left-right direction.

In an alternative embodiment, the first end portion 104 and the second end portion 110 are dense or rigid as compared to the middle portion 114 such that the positional support device 100 conforms to the shape depicted in FIGS. 1-6 under weight from the patient 144 in the prone position. In this regard, the rigidity or density of the first end portion 104 and the second end portion 110 may be the same or different as compared to each other and the middle portion 114 in accordance with patient requirements without departing from the scope of the present disclosure.

With reference to FIG. 2, the first end portion 104 defines a first end face 154 extended flatly in the top-bottom direction and the front-back direction. With this construction, a normal direction from the first end face 154 extends leftward in the left-right direction. Referring back to FIG. 1, the second end portion 110 defines a second end face 160 extended flatly in the top-bottom direction and the front-back direction, parallel to the first end face 154. With this construction, a normal direction from the second end face 160 extends rightward in the left-right direction. Also, the body 102 is compact in the left-right direction, minimizing a corresponding width of the support surface 140 necessary for stably supporting the positional support device 100.

With continued reference to FIG. 1, the bottom surface 120 and the front surface 124 form an edge 162 of the body 102 extended from the first end face 154 to the second end face 160 in the left-right direction. The edge 162 includes a first edge portion 164 at the first end portion 104, a second edge portion 170 at the second end portion 110, and a third edge portion 172 at the middle portion 114, such that the third edge portion 172 is interposed between and separates the first edge portion 164 and the second edge portion 170.

The third edge portion 172 has a radius of curvature smaller than each of the first edge portion 164 or the second edge portion 170. The front surface 124 of the body 102 at the middle portion 114, including the third edge portion 172, has a relatively shallow vertical incline as compared to the back surface 130. With this construction, the third edge portion 172 minimizes an incongruity with the support surface 140 where the patient 144 lays over the middle portion 114. As such, the third edge portion 172 having a relatively small radius of curvature as compared to the first edge portion 164 and the second edge portion 170 minimizes an amount of pressure that the body 102 imparts on the patient 144, including pressure directly imparted from the third edge portion 172 to the pelvis 150.

Also, the first edge portion 164 and the second edge portion 170 each having a radius of curvature larger than the third edge portion 172 increases a corresponding incongruity with the support surface 140, where the body 102 may be more readily gripped and maneuvered about the support surface 140 by a user. In this manner, the first edge portion 164 and the second edge portion 170 form grip features that enable a user to manipulate the positional support device, while the third edge portion 172 minimizes an amount of pressure imparted to the patient 144.

The top surface 122 and the back surface 130 form a corner 174 of the body 102 that is another edge extended from the first end face 154 to the second end face 160 in the left-right direction. The corner 174 includes a first corner portion 180 at the first end portion 104, a second corner portion 182 at the second end portion 110, and a third corner portion 184 at the middle portion 114, such that the third corner portion 184 is interposed between and separates the first corner portion 180 and the second corner portion 182.

The corner 174 is rounded such that the top surface 122 extends smoothly into the back surface 130 at the first corner portion 180, the second corner portion 182, and the third corner portion 184. With this construction, the third corner portion 184 minimizes an amount of pressure imparted to the patient 144 at the top surface 122 and the back surface 130. Also, the first corner portion 180 and the second corner portion 182 conform to a grip of a user for maneuvering and manipulating the positional support device 100 about the support surface 140.

The third corner portion 184 has a radius of curvature larger than the third edge portion 172. With this construction, the third corner portion 184 minimizes an incongruity between the body 102 and the patient 144 at the middle portion 114. As such, the third corner portion 184 minimizes an amount of pressure imparted onto the patient 144 from the body 102 at the third corner portion 184 when the patient lays over the positional support device 100 in the prone position.

The bottom surface 120 and the back surface 130 form a vertex 190 that is another edge extended from the first end face 154 to the second end face 160 in the left-right direction. As shown in FIG. 2, the vertex 190 includes a first vertex portion 192 at the first end portion. As shown in FIG. 1, the vertex 190 includes a second vertex portion 194 at the second end portion 110.

With reference to FIG. 3, the first end portion 104, the second end portion 110, and the middle portion 114 define a channel 200 that extends smoothly and continuously from the front surface 124 at the third edge portion 172 to the top surface 122 at the third corner portion 184. In this manner, the first end portion 104, the second end portion 110, and the middle portion 114 define the channel 200 along an entire length of the front surface 124 and the top surface 122 in the front-back direction.

The first end portion 104 and the second end portion 110 each form a rounded inner corner 202 with the middle portion 114. The rounded inner corners 202 are smooth surfaces that respectively continuously extend from the first end portion 104 and the second end portion 110 to the middle portion 114. The rounded inner corners 202 each have a curvature corresponding to the pelvis 150 of the patient 144, and evenly distribute pressure between the body 102 and the patient 144 at the pelvis 150 when the patient 144 lays over the positional support device 100 in the prone position.

In an embodiment, the curvatures of the rounded inner corners 202 may be based on a measurement of the patient 144, such as, for example, a laser measurement, a weight measurement, a height measurement, or a hip measurement. In such an embodiment, forming the body 102 may include forming the first end portion 104, the second end portion 110, or the middle portion 114 in an additive manufacturing process based on the measurement, including forming a height of the top surface 122 from the bottom surface 120 in the top-bottom direction, a length of the top surface 122 in the front-back direction, an incline angle of the front surface 124 in the top-bottom direction, a width of the middle portion 114 in the left-right direction, or a height of the first end portion 104 or the second end portion 110 relative to the middle portion 114 in the top-bottom direction based on the measurement.

The additive manufacturing process may be 3D printing performed by techniques such as, for example, vat photopolymerization, material extrusion, powder bed fusion, material jetting, binder jetting, directed energy deposition, or sheet lamination. The body 102 may additionally be formed through injection molding or blow molding, or via other fabrication techniques, such that the resulting positional support device 100 is customized for a particular patient.

In embodiments utilizing additive manufacturing fabrication to form the body 102, an internal weave pattern of material may be configured to provide a desired support position when under compression, e.g., when the patient 144 is placed on the positional support device 100. In such embodiments, the first end portion 104 and the second end portion may be fabricated to have a first density and shape, while the middle portion 114 is fabricated to have a second density and shape. In such embodiments, the first end portion 104, the second end portion 110, and the middle portion 114 are made from a foam such as, for example, polyurethane foam, memory foam, latex foam, and closed-cell foam. The body 102 may additionally or alternatively include a gel, such as, for example, silicone gel, hydrogel, and polyurethane gel. The body 102 may additionally or alternatively include, for example, a plastic or polymer such as polycarbonate, polyethylene, polypropylene, or a thermoplastic. The body 102 may additionally or alternatively include a carbon fiber composite.

In this manner, a length, width, and height of the positional support device 100 may be varied to accommodate different patients including the patient 144, e.g., small, medium, large, etc. patients, or alternatively, may be customized in accordance with patient requirements. As such, the positional support device 100 may be a customized unit, fabricated specifically for a particular patient.

With continued reference to FIG. 3, the rounded inner corners 202 extend continuously from the first end portion 104 to the second end portion 110, such that the channel 200 is concave along the top surface 122 and the front surface 124. The top surface 122 defining the channel 200 is concave in the top-bottom direction. The front surface 124 defining the channel 200 is concave in the top-bottom direction and the front-back direction.

In an embodiment, the concavity of the channel 200 is determined based on a measurement of the patient 144. In this regard, each of a radius of curvature, curvature ratio, angular span, sagitta, and chord length of the channel 200 may be determined based on a measurement of the patient 144, such that the concavity matches a best-fit curve of the patient 144 at the pelvis 150. In this manner, the channel 200 evenly distributes pressure from the patient 144 at the pelvis 150 when the patient 144 lays over the positional support device 100 in the prone position.

In an embodiment, a width of the channel 200 in the left-right direction is about 26-34 centimeters along the front surface 124 and the top surface 122, from the edge 162 to the corner 174. In a further embodiment, the height of the first end portion 104 or the second end portion 110 beyond the middle portion 114 in the top-bottom direction is about 3-9 centimeters along the front surface 124 and the top surface 122, from the edge 162 to the corner 174. In a further embodiment, the curvature ratio of the channel 200 is about 0.1-0.2 along the front surface 124 and the top surface 122, from the edge 162 to the corner 174. In a further embodiment, the angular span of the channel is about 90-120 degrees along the front surface 124 and the top surface 122, from the edge 162 to the corner 174. With this construction, the channel 200 is sized and shaped to generally match a broad range of patients, including the patient 144, for effectively dissipating pressure and retaining the patient 144 in the prone position without obstructing lateral or posterior access to the patient 144, including at the pelvis 150. In this manner, the positional support device 100 may maintain the position of the patient 144 for a posterior-based procedure, including at the sacroiliac (SI) joint.

With continued reference to FIG. 3, the body 102 is symmetric in the left-right direction. As such, the top surface 122 at the middle portion 114 extends straight in the front-back direction along an axis 204 that is a middle line of the body 102 equidistant from the first end portion 104 and the second end portion 110 in the left-right direction. With this construction, the body 102 is compact in the left-right direction, minimizing a corresponding width of the support surface 140 necessary for stably supporting the positional support device 100.

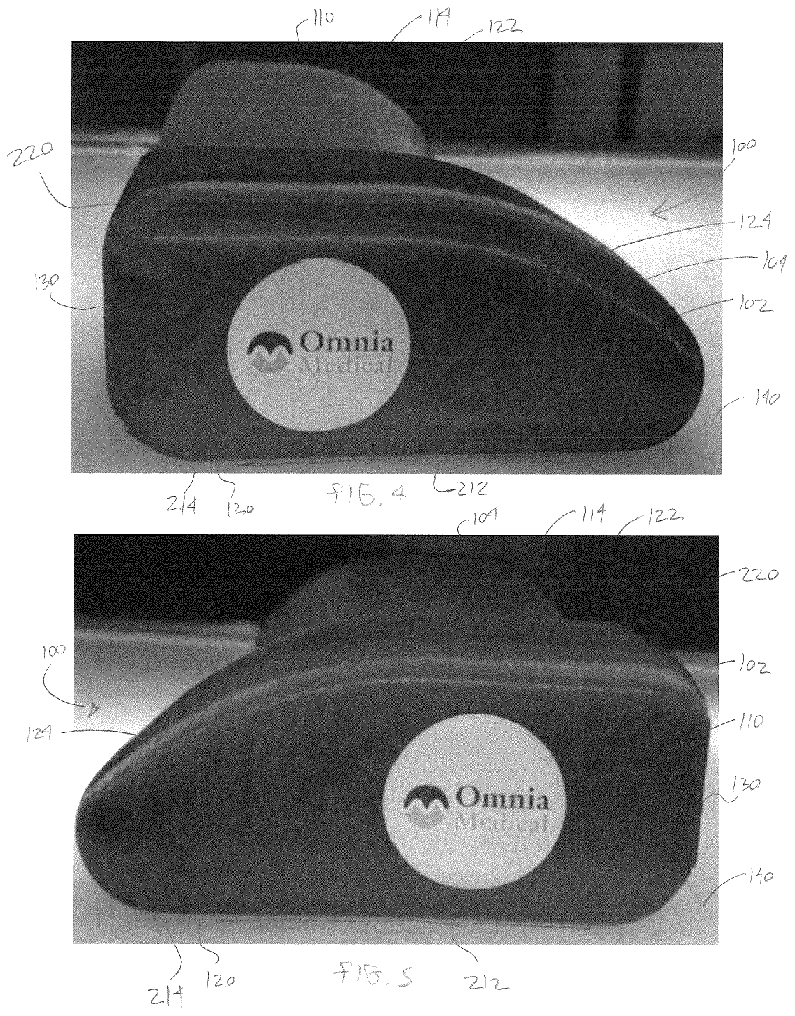

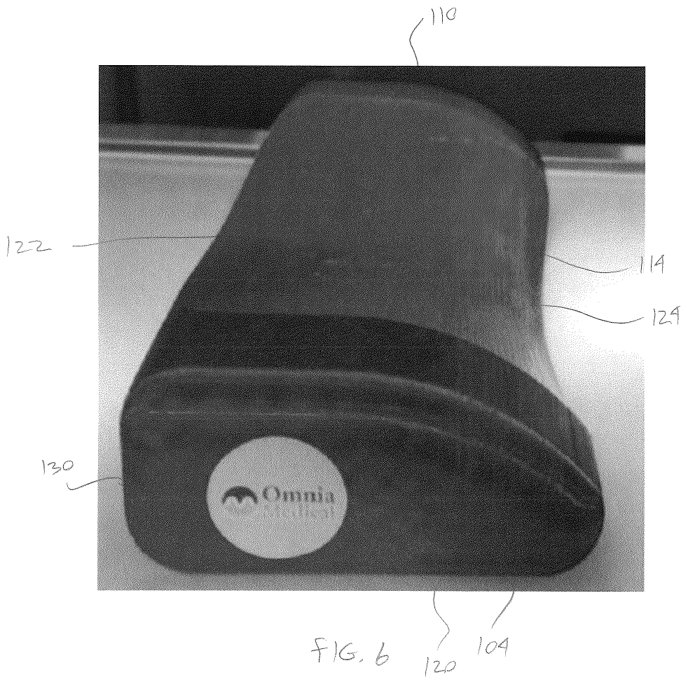

FIGS. 4 and 5 respectively depict left and right perspective views of the body 102. As shown in FIGS. 4 and 5, the top surface 122 extends straight in the front-back direction at the middle portion 114, parallel to the bottom surface 120, from the front surface 124 to an opposite end of the top surface 122 in the front-back direction.

The front surface 124 extends smoothly into the top surface 122 at the middle portion 114. The front surface 124 extends along the front-back direction at the middle portion 114, inclined in the top-bottom direction, and is convex from the bottom surface 120 to the top surface 122. The convex curvature of the front surface 124 in the top-bottom direction, along the front-back direction, matches a curvature of the patient 144 at the pelvis 150. As such, the front surface 124 evenly distributes pressure under weight from the patient 144, while ergonomically articulating the patient 144 in the prone position.

In an embodiment, the convex curvature of the front surface 124 is determined by performing a measurement of the patient 144, such as, for example, a laser measurement, a weight measurement, a height measurement, or a hip measurement. In such an embodiment, a radius of curvature corresponding to a bending degree of the patient 144, a chord length corresponding to a contact distance between the front surface 124 and the patient 144, or a sagitta corresponding to an elevation of the pelvis 150 may be determined based on the measurement.

With continued reference to FIGS. 4 and 5, in an embodiment, the convex curvature of the front surface 124 elevates the pelvis about 5-20 centimeters. In a further embodiment, the convex curvature of the front surface 124 elevates the pelvis about 5-10 centimeters. A curvature ratio defined as a sagitta to chord length ratio with respect to the convex curvature of the front surface 124 may be about 0.1-0.2. In an alternative embodiment, the curvature ratio may be about 0.3-0.4, providing a more pronounced lift in the pelvis 150. The convex curvature of the front surface 124 has angular span of about 60-90 degrees, providing ergonomic support at the pelvis 150 without causing hyperextension. In this manner, the positional support device 100 may maintain the position of the patient 144 for a posterior-based procedure, including at the sacroiliac (SI) joint.

With this construction, the body 102 has a profile in the left-right direction that is a rounded right trapezoid with a curved side corresponding to the front surface 124. More specifically, the bottom surface 120, the top surface 122, the front surface 124, and the back surface 130 form a rounded right trapezoid-shaped cross-section at the first end portion 104, the second end portion 110, and the middle portion 114 in the left-right direction. The rounded right trapezoid profile at the middle portion 114 is similar to, and reduced from the rounded right trapezoid profile at the first end portion 104 and the second end portion 110 in the top-bottom direction and the front-back direction at the top surface 122 and the front surface 124.

As shown in FIG. 3, the body 102 is a unitary body, where the first end portion 104, the second end portion 110, and the middle portion 114 are integrally formed with each other. In the depicted embodiment, the body 102 is formed from a semi-rigid gel composite structure. In alternative embodiments, the body 102 may be formed by gel alone or in combination with a plurality of shaped rigid or semi-rigid components within the shell 210 without departing from the scope of the present disclosure. The body 102 may additionally or alternatively be formed from a foam, plastic, polymer, or carbon fiber configuration as described above.

The positional support device 100 includes a shell 210 that encases the body 102, including the first end portion 104, the second end portion 110, and the middle portion 114. The shell 210 covers each of the bottom surface 120, the top surface 122, the front surface 124, the back surface 130, the first end face 154, and the second end face 160 from an exterior environment of the body 102 with a water impermeable membrane and seal.

In an embodiment, the shell 210 is removable from the body 102. In an alternative embodiment, the shell 210 is integrally formed with the body 102. The shell 210 may include, without limitation, vinyl, polyvinyl chloride, polymers, or the like, providing a readily sterilized exterior surface of the positional support device 100.

As shown in FIGS. 4 and 5, the shell 210 includes fasteners 212 fixed to a bottom segment 214 of the shell 210 that corresponds to the bottom surface 120. The fasteners 212 are fixed to, and extend outwardly from a side of the bottom segment 214 opposite the bottom surface 120 in the top-bottom direction. The fasteners 212 are laminated grips fixed to the bottom segment 214 where the bottom segment 214 contact and generate increased traction between the support surface 140 and the positional support device 100. In an embodiment lacking the shell 210, the fasteners 212 may be fixed to the bottom surface 120 of the body 102.

More specifically, the bottom surface 120, the bottom segment 214, and the support surface 140 are flat, the body 102 is formed from a first material having a first coefficient of friction with the support surface 140. The fasteners 212 are laminated grips positioned on the bottom surface 120, where the fasteners extend flatly between the support surface 140, and the bottom surface 120 or the bottom segment 214. The fasteners 212 are formed from a second material that has a higher coefficient of friction with the support surface 140 than the first material, such that placing the bottom surface 120 or the bottom segment 214 on the support surface 140 includes directly contacting the support surface 140 with the fasteners 212 and increasing an overall coefficient of friction between the support surface 140, and the bottom surface 120 or the bottom segment 214. With this construction, the positional support device 100 resists slipping along the support surface 140 in the front-back direction and the left-right direction when oriented in the upright position. As such, the fasteners 212 retain a position of the positional support device 100, as well as the patient 144 on the positional support device 100 during any subsequent procedures.

While, as depicted, the fasteners 212 are laminated grips that increase a coefficient of friction with the support surface 140, the fasteners 212 may additionally or alternatively include hook and loop fasteners, buckles, straps, bands, clips, clamps, buttons, snaps, and other mechanical fasteners removable from the support surface 140 without departing from the scope of the present disclosure. In this regard, the support surface 140 may have complementary features, such as hook and loop fastener components, that engage the fasteners 212 and fix the positional support device 100 to the support surface 140. Furthermore, the fasteners 212 may embody a variety of frictional materials and configuration at the bottom surface 120 or the bottom segment 214, e.g., a coating, case, etc., that provides frictional resistance to movement of the positional support device 100 when placed on the support surface 140. Adhesive, mechanical, magnetic, electrostatic, or other suitable mechanisms may also be used to prevent movement of the positional support device 100 on the support surface 140.

The positional support device 100 may be fabricated in a variety of standard sizes, with the shell 210 being removable and replaceable with other similar shells to prevent contamination between patients and provide a sterile surface. In such embodiments, interior portions of the positional support device 100 may be fabricated via additive manufacturing (e.g., 3D printing), via injection or blow molding, or via other fabrication techniques, during a single operation, or multiple operations, where each of the first end portion 104, the second end portion 110, and the middle portion 114 thereafter is attached to form the positional support device 100. In an embodiment, the shell 210 is integral with the standard-sized versions of the positional support device 100, and may be constructed of a suitable material providing ease of cleaning, longevity, and the like. In some embodiments, a top segment 220 of the shell 210 corresponding to the top surface 122 of the body 102 may have a lower coefficient of friction with the support surface 140 than the bottom segment 214 to allow ease in positioning the patient 144. The top segment 220 of the shell 210 forms a portion of the shell 210 opposite the bottom segment 214 in the top-bottom direction.

An example method of manufacturing the positional support device 100 includes forming the body 102 having the first end portion 104, the second end portion 110 extended from the first end portion in a left-right direction, and the middle portion 114 interposed between and separating the first end portion 104 and the second end portion 110 in the left-right direction. In forming the body 102, the middle portion 114 includes the bottom surface 120 that is flat, and includes the top surface 122 that extends in the front-back direction parallel to the bottom surface 120, offset from the bottom surface 120 in the top-bottom direction. In forming the body 102, the middle portion 114 includes the front surface 124 that extends in the front-back direction, and is inclined in the top-bottom direction from the bottom surface 120 toward the top surface 122. In forming the body 102, the middle portion 114 includes the first end portion 104 and the second end portion 110 extended opposite from the first end portion 104 in the left-right direction. The first end portion 104 and the second end portion 110 extend beyond the middle portion 114 in the top-bottom direction along the front surface 124 and the top surface 122, or in the first end portion 104 and the second end portion 110 are dense or rigid as compared to the middle portion 114.

In an embodiment, the method of manufacturing the positional support device 100 includes performing a measurement of the patient 144, including performing a laser measurement, a weight measurement, a height measurement, or a hip measurement. In such an embodiment, forming the body 102 includes forming the first end portion 104, the second end portion 110, and the middle portion 114 in an additive manufacturing process based on the measurement. In this regard, the method may include forming a height of the top surface 122 from the bottom surface 120 in the top-bottom direction, a length of the top surface 122 in the front-back direction, an incline angle of the front surface 124 in the top-bottom direction, a width of the middle portion 114 in the left-right direction, or a height of the first end portion 104 and the second end portion 110 relative to the middle portion 114 in the top-bottom direction based on the measurement.

As shown in FIG. 2, an example method of using the positional support device 100 includes placing the bottom surface 120 of the positional support device 100 on the support surface 140, where the bottom surface 120 extends in the front-back direction and the left-right direction. The method of using the positional support device 100 also includes laying the patient 144 in a prone position on the support surface 140, over the positional support device 100.

In the example method, the top surface 122 of the positional support device 100 is offset from the bottom surface 120 in the top-bottom direction, extends straight along the front-back direction, and receives an anterior portion of the pelvis 150 of the patient 144. In the example method, the front surface 124 of the positional support device 100 extends in the front-back direction, is inclined downward in the top-bottom direction from the top surface 122 toward the bottom surface 120, receives the pelvis 150 of the patient 144, and is located closer to feet of the patient 144. In the example method, the back surface 130 of the positional support device 100 extends downward from the top surface 122 toward the bottom surface 120 at a smaller angle from the top-bottom direction than the front surface 124, and the abdomen 152 of the patient 144 extends beyond the back surface 130 in the front-back direction.

As shown in FIG. 4, in an embodiment of the method of using the positional support device 100, the bottom surface 120 and the support surface 140 are flat, the positional support device 100 includes the body 102 formed from a first material. The body 102 defines the top surface 122 and the bottom surface 120, the positional support device 100 includes a fastener 212 that is a laminated grip positioned on the bottom surface 120. The fastener 212 is formed from a second material that has a higher coefficient of friction with the support surface 140 than the first material, and placing the bottom surface 120 on the support surface includes directly contacting the support surface 140 with the fastener 212.

While specific embodiments are shown and described herein, it is contemplated that alternative embodiments exist that employ alternative materials, mixtures, proportions, sizes, etc. without departing from the spirit and/or scope of the innovation as described in detail. These alternative embodiments are to be included within the spirit and scope of the innovation as described and claimed herein.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

Further, the term “in” as used to describe an object with respect to a given direction (e.g., an edge extended in a left-right direction) is intended to denote an orientation that is substantially parallel to the specified direction. In contrast, the term “along” as used to describe an object with respect to a given direction (e.g., an edge extended along a vertical direction) is intended to indicate that a feature or element possesses a common vector component in that direction, even if its overall alignment is not strictly parallel.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A positional support device, comprising:
a bottom surface having a flat portion that extends in a front-back direction and a perpendicular left-right direction;
a top surface that extends straight along the front-back direction, and is offset from the bottom surface in a top-bottom direction perpendicular to the front-back direction and the left-right direction;
a front surface that extends along the front-back direction, inclined in the top-bottom direction from the top surface toward the bottom surface;
a first end portion and a second end portion extended opposite from the first end portion in the left-right direction; and
a middle portion interposed between and separating the first end portion and the second end portion in the left-right direction,
wherein the first end portion or the second end portion extend beyond the middle portion in the top-bottom direction along the front surface and the top surface, or wherein the first end portion or the second end portion are dense or rigid as compared to the middle portion.

2. The positional support device of claim 1, wherein the first end portion, the second end portion, and the middle portion define a channel that extends continuously from the front surface to the top surface.

3. The positional support device of claim 2, wherein the first end portion, the second end portion, and the middle portion define the channel along an entire length of the front surface and the top surface in the front-back direction.

4. The positional support device of claim 1, wherein the first end portion or the second end portion form a rounded inner corner with the middle portion, the rounded inner corner being a smooth surface that continuously extends from the first end portion or the second end portion to the middle portion.

5. The positional support device of claim 1, wherein the top surface and the front surface are concave in the top-bottom direction or the front-back direction, and the top surface at the middle portion extends straight in the front-back direction, parallel to the flat portion of the bottom surface, along an axis that is equidistant from the first end portion and the second end portion.

6. The positional support device of claim 1, wherein the front surface directly connects the bottom surface to the top surface, wherein the front surface extends along the front-back direction at the middle portion, inclined in the top-bottom direction, and is convex from the bottom surface to the top surface.

7. The positional support device of claim 6, wherein the front surface extends smoothly into the top surface at the middle portion, and
the top surface extends straight in the front-back direction at the middle portion, parallel to the bottom surface, from the front surface to a back surface at an opposite end of the top surface in the front-back direction.

8. The positional support device of claim 1, further comprising a back surface opposite the front surface in the front-back direction, wherein the back surface extends from the top surface toward the bottom surface at a smaller angle from the top-bottom direction than the front surface.

9. The positional support device of claim 8, wherein a corner formed between the top surface and the back surface at the middle portion is rounded such that the top surface extends smoothly into the back surface.

10. The positional support device of claim 8, wherein the bottom surface, the top surface, the front surface, and the back surface form a right trapezoid-shaped cross-section at the first end portion, the second end portion, or the middle portion in the left-right direction.

11. The positional support device of claim 1, wherein an edge formed between the front surface and the bottom surface includes a first edge portion at the first end portion or a second edge portion at the second end portion, and includes a third edge portion at the middle portion, and the third edge portion has a radius of curvature smaller than each of the first edge portion or the second edge portion.

12. The positional support device of claim 11, further comprising a back surface opposite the front surface in the front-back direction, wherein the back surface and the top surface form a corner having a radius of curvature larger than the third edge.

13. The positional support device of claim 1, wherein the first end portion, the second end portion, and the middle portion are integrally formed with each other, and together form a unitary body.

14. The positional support device of claim 13, further comprising a shell that encases the unitary body including the first end portion, the second end portion, and the middle portion.

15. The positional support device of claim 14, further comprising fasteners fixed to a bottom segment of the shell that corresponds to the bottom surface, wherein the fasteners are fixed to, and extend outwardly from a side of the bottom segment opposite the bottom surface.

16. The positional support device of claim 13, wherein the unitary body is formed from a semi-rigid gel composite structure or a foam.

17. A method of using a positional support device, the method comprising:
placing a bottom surface of the positional support device on a horizontal support surface, wherein the bottom surface extends along the support surface in a front-back direction and a perpendicular left-right direction; and
laying a patient in a prone position on the support surface, over the positional support device,
wherein a top surface of the positional support device is offset from the bottom surface in a top-bottom direction perpendicular to the front-back direction and the left-right direction, extends straight along the front-back direction, and receives an anterior portion of a pelvis of the patient,
a front surface of the positional support device extends along the front-back direction, inclined downward in the top-bottom direction from the top surface toward the bottom surface, receives the pelvis of the patient, and
a back surface of the positional support device extends downward from the top surface toward the bottom surface at a smaller angle from the top-bottom direction than the front surface, such that an abdomen of the patient separates from and extends beyond the back surface along the front-back direction.

18. The method of claim 17, wherein the bottom surface and the support surface are flat, the positional support device includes a body formed from a first material, the body defines the top surface and the bottom surface, the positional support device includes a laminated grip positioned on the bottom surface, the laminated grip is formed from a second material that has a higher coefficient of friction with the support surface than the first material, and placing the bottom surface on the support surface includes directly contacting the support surface with the laminated grip.

19. A method of manufacturing a positional support device, the method comprising:
forming a body having a first end portion, a second end portion extended from the first end portion in a left-right direction, and a middle portion interposed between and separating the first end portion and the second end portion in the left-right direction, wherein the middle portion includes,
a bottom surface that has a flat portion extended in the left-right direction and a perpendicular front-back direction;
a top surface that extends straight along the front-back direction, and is offset from the bottom surface in a top-bottom direction perpendicular to the left-right direction and the front-back direction; and
a front surface that extends along the front-back direction, inclined in the top-bottom direction from the top surface toward the bottom surface;
wherein the first end portion or the second end portion extend beyond the middle portion in the top-bottom direction along the front surface and the top surface, or wherein the first end portion or the second end portion are dense or rigid as compared to the middle portion.

20. The method of claim 19, further comprising performing a measurement of a patient, including performing a laser measurement, a weight measurement, a height measurement, or a hip measurement,
wherein forming the body includes forming the first end portion, the second end portion, or the middle portion in an additive manufacturing process based on the measurement, including forming a height of the top surface from the bottom surface in the top-bottom direction, a length of the top surface in the front-back direction, an incline angle of the front surface in the top-bottom direction, a width of the middle portion in the left-right direction, or a height of the first end portion or the second end portion relative to the middle portion in the top-bottom direction based on the measurement.
